(19) United States
(12) Patent Application Publication
(10) Pub. No.: US 2020/0112441 A1
(43) Pub. Date: Apr. 9, 2020

(54) METHODS AND SYSTEMS FOR PERFORMING UNMALLEABLE EVENT LOGGING OF KEY MANAGEMENT FUNCTIONS USING DISTRIBUTED LEDGERS

(71) Applicant: Vermont Secure Computing Inc., Woodstock, VT (US)

(72) Inventors: Ian Spiro, Killington, VT (US); Gregg Spiro, Boxford, MA (US); Gary Jackson, Cumberland, RI (US); Thomas P. Hardjono, Winchester, MA (US)

(21) Appl. No.: 16/597,337

(22) Filed: Oct. 9, 2019

Related U.S. Application Data
(60) Provisional application No. 62/743,335, filed on Oct. 9, 2018.

(51) Int. Cl. H04L 9/32

(52) U.S. Cl. CPC H04L 9/3247; H04L 2209/38; H04L 9/3242

(57) ABSTRACT

Methods and systems are disclosed for capturing and storing unmalleable evidence regarding the management of cryptographic keys and the application of keys to transaction data, where multiple hardware components are synchronized on an on-going basis to generate an interlinked proof and where the combined evidence are cryptographically merged into a singular hierarchical proof that is then recorded simultaneously on nodes of a distributed ledger system or blockchain system.

### CROSS REFERENCE TO RELATED APPLICATION

This application claims priority from U.S. Provisional Patent Application No. 62/743,335 filed on Oct. 9, 2018 entitled METHODS AND SYSTEMS FOR PERFORMING UNMALLEABLE EVENT LOGGING OF KEY MANAGEMENT FUNCTIONS USING DISTRIBUTED LEDGERS, which is hereby incorporated by reference.

### BACKGROUND

The present application generally relates to methods and systems for capturing and storing unmalleable evidence regarding the management of cryptographic keys and the application of keys to transaction data, where multiple hardware components are synchronized on an on-going basis to generate an interlinked proof and where the combined evidence are cryptographically merged into a singular hierarchical proof that is then recorded simultaneously on nodes of a distributed ledger system or blockchain system.

### BRIEF SUMMARY OF THE DISCLOSURE

A method of logging events in an event logging system in accordance with one or more embodiments includes the steps of: (a) submitting an unsigned transaction, by a Transaction Issuance System (TIS), to a Transaction Signing System (TSS) and recording the unsigned transaction to an External Logging System (ELS); (b) digitally signing the unsigned transaction, by the TSS, to create a signed transaction and returning the signed transaction to the TIS; (c) transmitting the signed transaction, by the TSS, to a Local Logging System (LLS); (d) merging, by the LLS, the signed transaction received from the TSS into a log system, and generating a merge-proof, and transmitting the merge-proof to the ELS; (e) determining, by the TIS, that the signed transaction data corresponds to the unsigned transaction, and forwarding the signed transaction to the ELS; (f) recording, by the LLS, the most recent log entry to a blockchain system; (g) verifying and merging, by the ELS: (i) the unsigned transaction from step (a), (ii) the merge-proof from step (d), and (iii) the signed transaction obtained in step (e); and triggering an alarm notification when a discrepancy is determined; and (h) generating, by the ELS, a proof of successful merging, and recording the proof to the blockchain system.

A system for logging events in an event logging system in accordance with one or more embodiments includes a Transaction Issuance System (TIS), a Transaction Signing System (TSS), an External Logging System (ELS), a Local Logging System (LLS). The system is configured to: (a) submit an unsigned transaction, by a Transaction Issuance System (TIS), to a Transaction Signing System (TSS) and record the unsigned transaction to an External Logging System (ELS); (b) digitally sign the unsigned transaction, by the TSS, to create a signed transaction and return the signed transaction to the TIS; (c) transmit the signed transaction, by the TSS, to a Local Logging System (LLS); (d) merge, by the LLS, the signed transaction received from the TSS into a log system, and generate a merge-proof, and transmit the merge-proof to the ELS; (e) determine, by the TIS, that the signed transaction data corresponds to the unsigned transaction, and forward the signed transaction to the ELS; (f) record, by the LLS, the most recent log entry to a blockchain system; (g) verify and merge, by the ELS: (i) the unsigned transaction from step (a), (ii) the merge-proof from step (d), and (iii) the signed transaction obtained in step (e); and trigger an alarm notification when a discrepancy is determined; and (h) generate, by the ELS, a proof of successful merging, and recording the proof to the blockchain system.

### BRIEF DESCRIPTION OF THE DRAWINGS

FIG. 1 is a schematic block diagram providing a high-level view of an exemplary event logging system in accordance with one or more embodiments.

FIG. 2 depicts exemplary log entries from the LLS and ELS of FIG. 1 that are hash-chained using a hardware-based key and keyed-hash algorithm in accordance with one or more embodiments.

FIG. 3 depicts an exemplary closed feedback loop the system of FIG. 1 in accordance with one or more embodiments.

FIG. 4 depicts exemplary log entries of the logging system in accordance with one or more embodiments.

FIG. 5 depicts multiple independent logging systems sharing a common blockchain in an interlocked fashion in accordance with one or more embodiments.

FIG. 6 is a simplified block diagram illustrating one example of a computer system, in which various components of the event logging system in accordance with one or more embodiments may be implemented.

Like or identical reference numbers are used to identify common or similar elements.

### DETAILED DESCRIPTION

### System Overview

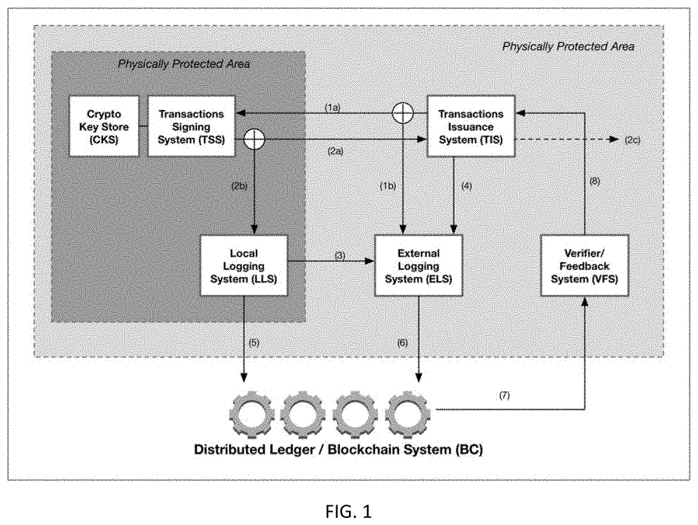

FIG. 1 is a schematic block diagram providing a high-level view of an exemplary event logging system for key management lifecycle in accordance with one or more embodiments. A given Transaction Issuance System (TIS) is used by a User to create unsigned transactions. An unsigned transaction is submitted by the TIS to the Transaction Signing System (TSS), which perform the digital signature application over the relevant unsigned transaction data, using the cryptographic keys located in the Crypto Key Store (CKS) that is physically attached to the Transaction Signing System. Both the TSS and CKS are located within a physically secure area (e.g. physical vault).

An exemplary process in accordance with one or more embodiments includes the following steps:
Step 1a: The flow begins with a transaction being submitted by the Transaction Issuance System (TIS) to the Transaction Signing System (TSS).
Step 1b: Simultaneously the TIS records a copy of every unsigned transaction to the External Logging System (ELS).
Step 2a: The TSS digitally signs the relevant parts of the transaction payload data, returns the signed transaction to the TIS. The TIS checks that the signed transaction data is the same as was submitted by the TIS in Step 1(a).
Step 2b: Simultaneously the TSS records a copy of the signed transaction payload data to the Local Logging System (LLS).
Step 2c: The TIS forwards the signed transaction payload data (received in Step 2(a)) out to an external transaction trading system.
Step 3: The LLS merges the copy (of the signed transaction payload data) it received from the TSS from Step 2(b) into its own secure log system, and generates a proof of successful merging (merge-proof). It transmits the merge-proof to the External Logging System (ELS).
Step 4: The TIS having checked that the signed transaction data is the same as was submitted by the TIS in Step 1(a), forwards a copy of the signed transaction to External Logging System (ELS).
Step 5: The LLS records a copy of the most recent log entry (i.e. the head of the chained log) to the corporate blockchain system.
Step 6: The External Logging System (ELS) verifies the following and then merges the three items into its log system:
   (i) the original unsigned transaction data from Step 1(a);
   (ii) the proof of successful merging from the LLS in Step 3.
   (iii) The copy of the signed transaction obtained from the TIS in Step 4.
   Any discrepancy triggers an alarm notification to the Security Administration. The ELS then generates a proof of successful merging, and records it to the corporate blockchain system.
Step 7: At regular intervals the Verifier/Feedback System (VFS) performs the validation of all the entries in the corporate blockchain system pertaining to the logging activities. It compares the entries recorded by the LLS in Step 5 against the entries recorded by the ELS in Step 6 . Any discrepancy triggers an alarm notification to the Security Administration.
Step 8: Additionally, the VFS system computes a status-trace (hash of the relevant entries in the confirmed in the corporate blockchain) and feed that value into the next unsigned transaction to be created by the Transaction Issuance System (TIS) in the next cycle of Step 1(a).

Features of an exemplary system in accordance with one or more embodiments include the following:

### Hash-Chained Log Entries

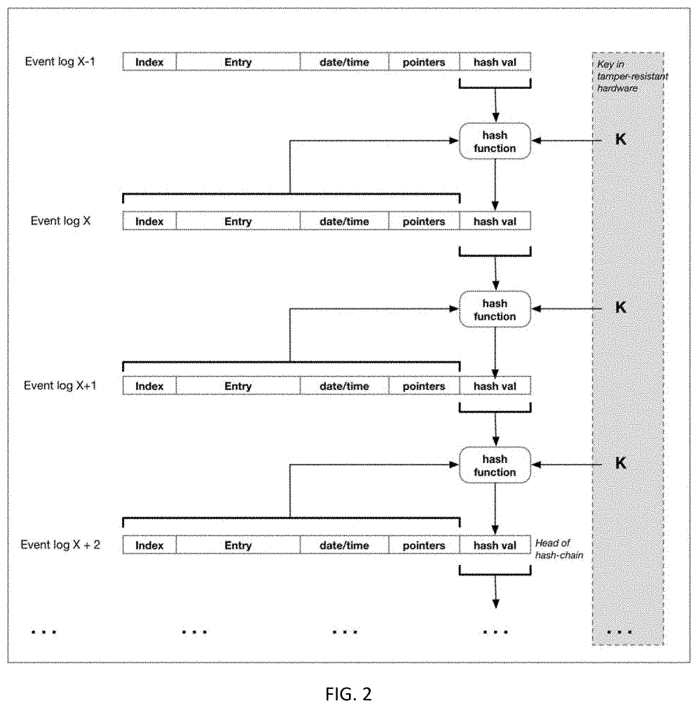

The Local Logging System (LLS) and the External Logging System (ELS) utilize a forward-hash method for recording entries based on the data submitted into the log in accordance with one or more embodiments. FIG. 2 depicts exemplary log entries that are hash-chained using a hardware-based key and keyed-hash algorithm.

In addition to the forward hash-chained mechanism to retain the integrity of each log-entry, features of this scheme in accordance with one or more embodiments can include:
Keys are in tamper resistant hardware on the log system: both the LLS and ELS log system embody tamper-resistant hardware to store keys (K) that are used to compute the log entries, using a keyed-hash function. Furthermore, the keyed-hash function itself uses a hardware-based embodiment, preventing the hash function from being replaced or attached (e.g. by malware).
Current head-of-chain recorded on the blockchain: At regular intervals the LLS and ELS log systems independently record their respective latest head of their log hash-chain to the blockchain system. The interval length is a configurable parameter on the LLS and ELS log systems. As such, each of these systems may have differing intervals for recording their latest head of hash-chain values.
Hash of current key K is logged and recorded on blockchain: At the commencement of the use of key K, a hash of the key K is computed and stored on the blockchain system together with the relevant metadata information (e.g. commencement time; keyed; etc.).
New Hash key K is automatically self-generated at periodic intervals: Each of the LLS and ELS log system embody tamper-resistant hardware that is capable of generating new keys K′ (K prime) at periodic intervals of time. The interval length is a configurable parameter on the LLS and ELS log systems independently.
Key roll-overs recorded on the blockchain: The change-over from a hash key K to a new key K′ (K prime) is recorded also on the Blockchain system.
   Closed Feed-Back Loop System Feeding into an Immutable Blockchain

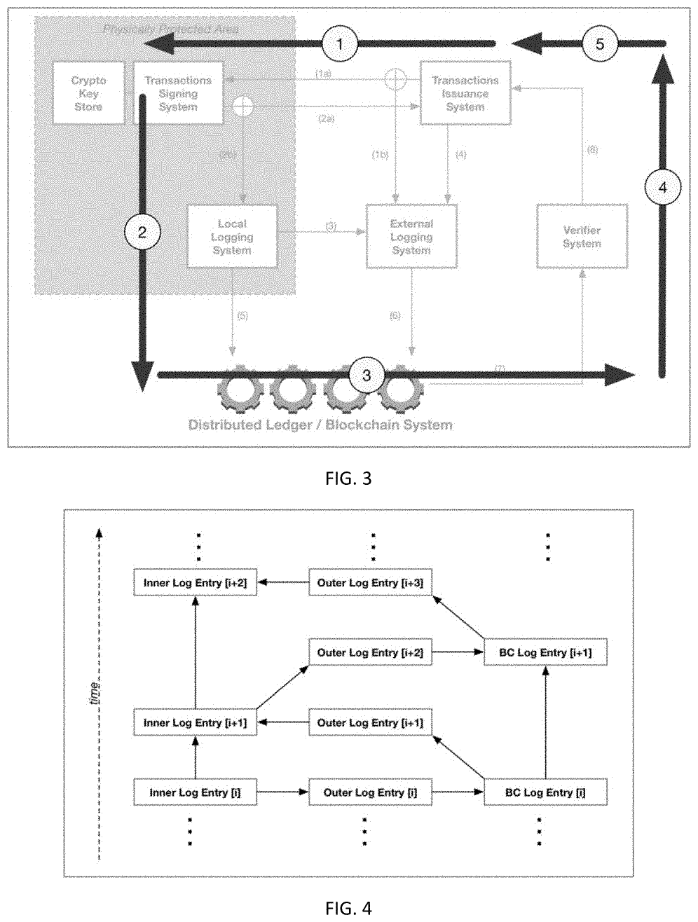

Another feature of the logging system for the key management lifecycle in accordance with one or more embodiments is its use of a feed-back loop that is (a) closed, and (b) feeds into a blockchain system that represents an immutable distributed ledger:
Closed feed-back loop: An exemplary loop of the system is shown in FIG. 3. It begins with Segment 1 at the Transaction Issuance System (TIS). By the end of Segment 2, both the Local Logging System (LLS) and the External Logging System (ELS) have recorded their latest log entry (i.e., latest head of their log hash-chain) into the blockchain.
In Segment 4 the Verifier Feedback System (VFS) reads the latest entry (i.e., hash entry) on the blockchain (containing the confirmed block entries from the LLS and ELS), and feeds that blockchain entry into the new unsigned transaction payload currently at the Transaction Issuance System (TIS). We refer to the latest blockchain entry selected by the VFS as the status-trace value.
The process repeats again starting in Segment 1, with the status-trace value embedded into (i.e., hashed into) payload of the new unsigned transaction.
Loop feeding into immutable blockchain: One aspect of the logging system is the fact that the logging data is recorded as part of an immutable blockchain with the benefit that any unauthorized modifications to the log entries in Local Logging System (LLS) or the External Logging System (ELS) will be detected. The first point of detection will be the Verifier Feedback System (VFS).

### Synchronized Cumulative Logs Recorded on Blockchain

In accordance with one or more embodiments, the logging system provides a mechanism for the synchronization of the two log systems (Local Logging System (LLS) and the External Logging System (ELS)), through the use of the blockchain.

The latest log entry (i.e. latest head of hash-chain) from the Local Logging System is simultaneously recorded on the blockchain (in Step 5 of FIG. 1 Error! Reference source not found.) and recorded into the log of the External Logging System (in Step 3 of FIG. 1).

In effect, when the ELS itself records its log onto the blockchain system (Step 6 of FIG. 1 Error! Reference source not found.), it carries the cumulative logs from Local Logging System.

### Detection of Unauthorized Tampering of Logs

In accordance with one or more embodiments, the Local Logging System (LLS) performs two types of captures/recoding of its latest head of hash-chain. First, it records the hash-value to the blockchain system in Step 5 of FIG. 1. This ensures that any unauthorized modifications of the local log entries (subsequent to the blockchain recording) will be detectable by virtue of the incorrect match of hash values between the modified-log and the immutable blockchain.

Second, the External Logging System (ELS) itself compares any log-updates received from the ILS against a combination of its own logs and the blockchain.

Any detection of mismatches indicates unauthorized tampering or system error, and either (or both) of the ILS and the ELS will raise alarms and halt the transaction-signing workflow.

### Hierarchical Log Structure Across Multiple Logs

In accordance with one or more embodiments, the data and metadata recorded in the entries of the logging system achieves a hierarchical logical structure across time, in which the base of the hierarchy represents older log entries across the same time frame as depicted, e.g., in FIG. 4.

### Multiple Log Systems Interlocked to a Distributed Ledger

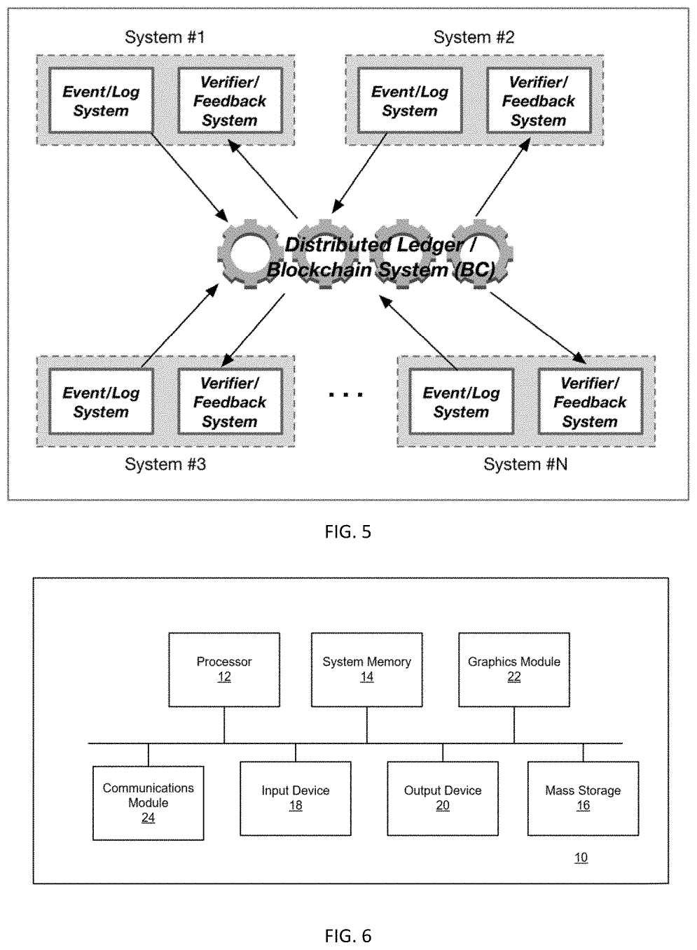

In accordance with one or more embodiments, one feature of the logging system is its ability to support multiple independent logging systems sharing a common blockchain in an interlocked fashion as depicted, e.g., in FIG. 5.
An Enterprise organization may operate multiple independent key management systems, each possessing its own event logging system. The key management systems may or may not serve the same applications (needing the keys). However, event logging for each of the key applications provides for the operational safety and consistency of the organization.
The design for the key management event logging uses the blockchain as a way to provide a consistent history of key management functions across all event logging systems (i.e., Systems 1 to N) that prevents the undetected modification of one or more of the log entries in these systems.
Since each system writes-to and reads-from the shared blockchain inside the organization, the summary (head of hash-chain inside each respective log) is recorded on the blockchain and becomes input into the next cycle of the other event logging system. As such, these set of event logging systems become interlocked with each other over time.
The retirement of an existing event logging system or the introduction of a new event logging system can be performed seamlessly without interruption to existing event logging system. This is because the shared blockchain represents an append-only historical record of all the key management functions that occurred inside the entire organization.

The methods, operations, modules, and systems described herein may be implemented in one or more computer programs executing on programmable computer systems. Various components of the exemplary event logging system (e.g., the Transaction Issuance System (TIS), the Transaction Signing System (TSS), the External Logging System (ELS), the Local Logging System (LLS), and the Verifier/Feedback System (VFS)) may each comprise one or more programmable computer systems.

FIG. 6 is a simplified block diagram illustrating one example of a computer system 10, on which the computer programs may operate as a set of computer instructions. The computer system 10 includes at least one computer processor 12, system memory 14 (including a random access memory and a read-only memory) readable by the processor 12. The computer system also includes a mass storage device 16 (e.g., a hard disk drive, a solid-state storage device, an optical disk device, etc.). The computer processor 12 is capable of processing instructions stored in the system memory or mass storage device. The computer system may additionally include input/output devices 18, 20 (e.g., a display, keyboard, pointer device, etc.), a graphics module 22 for generating graphical objects, and a communication module or network interface 24, which manages communication with other devices via networks.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting.

1. A method of logging events in an event logging system, comprising the steps of:
(a) submitting an unsigned transaction, by a Transaction Issuance System (TIS), to a Transaction Signing System (TSS) and recording the unsigned transaction to an External Logging System (ELS);
(b) digitally signing the unsigned transaction, by the TSS, to create a signed transaction and returning the signed transaction to the TIS;
(c) transmitting the signed transaction, by the TSS, to a Local Logging System (LLS);
(d) merging, by the LLS, the signed transaction received from the TSS into a log system, and generating a merge-proof, and transmitting the merge-proof to the ELS;
(e) determining, by the TIS, that the signed transaction data corresponds to the unsigned transaction, and forwarding the signed transaction to the ELS;
(f) recording, by the LLS, the most recent log entry to a blockchain system;
(g) verifying and merging, by the ELS: (i) the unsigned transaction from step (a), (ii) the merge-proof from step (d), and (iii) the signed transaction obtained in step (e); and triggering an alarm notification when a discrepancy is determined; and
(h) generating, by the ELS, a proof of successful merging, and recording the proof to the blockchain system.

2. The method of claim 1, further comprising after step (b): determining, by the TIS, that the signed transaction corresponds to the unsigned transaction previously submitted in step (a).

3. The method of claim 1, further comprising after step (c), sending the signed transaction by the TIS to an external transaction trading system.

4. The method of claim 1, further comprising periodically validating, by a Verifier/Feedback System (VFS), the entries in the blockchain system pertaining to the logging activities by comparing the entries recorded by the LLS in step (f) against the entries recorded by the ELS in step (h), and triggering an alarm notification when a discrepancy is determined.

5. The method of claim 1, further comprising computing, by the VFS, a status-trace comprising a hash of the relevant entries in the confirmed in the blockchain system, and feeding the hash into a new unsigned transaction submitted by the TIS to be signed.

6. A system for logging events in an event logging system, comprising a Transaction Issuance System (TIS), a Transaction Signing System (TSS), an External Logging System (ELS), a Local Logging System (LLS), wherein the system is configured to:
(a) submit an unsigned transaction, by a Transaction Issuance System (TIS), to a Transaction Signing System (TSS) and record the unsigned transaction to an External Logging System (ELS);
(b) digitally sign the unsigned transaction, by the TSS, to create a signed transaction and return the signed transaction to the TIS;
(c) transmit the signed transaction, by the TSS, to a Local Logging System (LLS);
(d) merge, by the LLS, the signed transaction received from the TSS into a log system, and generate a merge-proof, and transmit the merge-proof to the ELS;
(e) determine, by the TIS, that the signed transaction data corresponds to the unsigned transaction, and forward the signed transaction to the ELS;
(f) record, by the LLS, the most recent log entry to a blockchain system;
(g) verify and merge, by the ELS: (i) the unsigned transaction from step (a), (ii) the merge-proof from step (d), and (iii) the signed transaction obtained in step (e); and trigger an alarm notification when a discrepancy is determined; and
(h) generate, by the ELS, a proof of successful merging, and recording the proof to the blockchain system.

7. The system of claim 6, wherein the TIS is further configured to after step (b): determine that the signed transaction corresponds to the unsigned transaction previously submitted in step (a).

8. The system of claim 6, wherein the TIS is further configured to after step (c), send the signed transaction by the TIS to an external transaction trading system.

9. The system of claim 6, further comprising a Verifier/Feedback System (VFS) configured to periodically validate the entries in the blockchain system pertaining to the logging activities by comparing the entries recorded by the LLS in step (f) against the entries recorded by the ELS in step (h), and trigger an alarm notification when a discrepancy is determined.

10. The system of claim 6, wherein the VFS is further configured to compute a status-trace comprising a hash of the relevant entries in the confirmed in the blockchain system, and feed the hash into a new unsigned transaction submitted by the TIS to be signed.
